(19) United States
(12) Patent Application Publication
(10) Pub. No.: US 2014/0299807 A1
(43) Pub. Date: Oct. 9, 2014

(54) VARIABLE BALL VALVE AND METHODS OF USE

(71) Applicant: Mark A. Boys, Aromas, CA (US)

(72) Inventor: Mark A. Boys, Aromas, CA (US)

(21) Appl. No.: 14/216,815

(22) Filed: Mar. 17, 2014

Related U.S. Application Data
(60) Provisional application No. 61/799,289, filed on Mar. 15, 2013.

(51) Int. Cl. F16K 3/24

(52) U.S. Cl. CPC F16K 3/24
USPC 251/304

(57) ABSTRACT

An apparatus includes a variable valve placed into the interior of a ball valve for various advantages. In one embodiment a variable valve comprised of rollers is engineered into a standard ball valve thereby providing the advantages of the high sealing pressure of a ball valve and the fine flow control of a variable valve using rollers. In one embodiment a plurality of variable ball valves enhance flow in a system. In another embodiment superior sealing and high pressure operation is achieved. In another embodiment high voltage is added to ionize gasses.

### CROSS-REFERENCE TO RELATED DOCUMENTS

The present application claims priority to provisional application Ser. No. 61/799,289, filed on Mar. 15, 2013.

### BACKGROUND OF THE INVENTION

### Field of the Invention

The present invention is in the technical area of variable control valves. In the current art the most common way to vary the flow of a gas, liquid or other media is to make use of a butterfly valve or a ball valve. The problem with butterfly valves is in the way they are connected to the inner surface of the conduit. Typically the body or plate of the valve is attached to a rod. This rod is inserted into openings in the interior of the conduit to secure the plate. This is a very weak structure and cannot handle much pressure before failure. Another disadvantage of a butterfly valve is that the resulting flow on the downstream side of the valve is very turbulent. This causes problems when exacting pressure is needed for a certain application such as mixing gases etc . . . The pressure is hard to maintain because of the turbulent conditions. A further disadvantage of a butterfly valve is the significant resistance when the valve is fully open due to the stem and valve plate interfering with the continuous and even flow of gas liquid or other media.

A ball valve does not have the weakness aspect but does have significant turbulence. As a ball valve opens partially water is forced into the side of the conduit creating turbulence and cavitation. Cavitation is the formation of vapor cavities in a liquid—i.e. small liquid-free zones (“bubbles” or “voids”)—that are the consequence of forces acting upon the liquid. It usually occurs when a liquid is subjected to rapid changes of pressure that cause the formation of cavities where the pressure is relatively low. When subjected to higher pressure, the voids implode and can generate an intense shockwave.

Cavitation is a significant cause of wear in some engineering contexts. Collapsing voids that implode near to a metal surface cause cyclic stress through repeated implosion. Repeated implosion results in surface fatigue of the metal causing a type of wear also called “cavitation”. The most common examples of this kind of wear are to pump impellers and bends where a sudden change in the direction of liquid occurs. Cavitation is usually divided into two classes of behavior: inertial (or transient) cavitation and non-inertial cavitation.

Inertial cavitation is the process where a void or bubble in a liquid rapidly collapses, producing a shock wave. Inertial cavitation occurs in nature in the strikes of mantis shrimps and pistol shrimps, as well as in the vascular tissues of plants. In man-made objects, it can occur in control valves, pumps, propellers and impellers. Cavitation can also occur in a ball valve.

Non-inertial cavitation is the process in which a bubble in a fluid is forced to oscillate in size or shape due to some form of energy input, such as an acoustic field.

Since the shock waves formed by collapse of the voids are strong enough to cause significant damage to moving parts, cavitation is usually an undesirable phenomenon. It is very often specifically avoided in the design of valves. Eliminating cavitation is a major field in the study of fluid dynamics. However, it is sometimes useful and does not cause damage when the bubbles collapse away from machinery, such as in supercavitation.

What is clearly needed is a variable valve that has the strength and sealing characteristics of a ball valve with the ability to vary the flow in said valve with a minimum of turbulence and to handle very high pressures. What is also needed is a variable valve that is adapted to inject gas, liquid, solids, semisolids and or plasma into an existing media stream via hollow or semi hollow rollers adapted for said purpose.

### BRIEF SUMMARY OF THE INVENTION

One object of the invention is to provide a high pressure valve with a precise flow control with a minimum of turbulence and cavitation.

Another object of the invention is to provide a variable ball valve adapted to engineer flow control through a plurality of conduits including the ability of inducing a vortex for flow control.

Another object of the invention is to provide a variable flow adjustable ball valve capable of causing purposeful cavitation.

Another object of the invention is to provide a variable ball valve that is adapted to ionize gasses into an existing media stream with the ability to control the flow of said media stream very precisely and with high pressure sealing capabilities.

In one embodiment of the invention openings are incorporated into the interior of the rollers of a variable ball valve so that media may be mixed in this way.

Another aspect of the invention is to provide a variable ball valve with rounded shaped rollers. This shape causes less turbulence as gas or liquid flows through a conduit. In addition because of the cylindrical shape of the rollers a boundary layer effect enables the gas or media to flow more smoothly through the valve.

Another object of the invention is to provide a valve that is capable of splitting water through cavitation through electromagnetic frequency adjustments and or via the utilization of piezoelectric elements in rollers of valves.

Another object of the invention is to provide a variable flow valve inside a ball valve capable of hydraulic actuation, mechanical actuation, electrical actuation, wireless actuation and magnetic actuation.

Another object of the invention is to provide a variable flow valve inside a ball valve capable of being used to adjust PH and to mix chemicals as they are moving through the conduit.

Another object of the invention is to provide a variable valve incorporating a transformer into the interior of one or each rollers so that the high voltage may be accomplished in this way. In this way one can control high pressure gas with precision with a variable valve that has a high pressure seal and at the same time ionize said gas with high voltage of any frequency.

Another object of the invention is to provide a variable valve with sensors that can detect shock waves in any media and alter said waves to a different form.

### BRIEF DESCRIPTION OF THE SEVERAL VIEWS OF THE DRAWINGS

FIG. 1 is an illustration of turbulence patterns in a typical state of the art butterfly valve.

FIG. 2 is an illustration of turbulence patterns in a typical state of the art ball valve.

FIG. 3 is an illustration of a variable valve in the closed position according to one embodiment of the present invention.

FIG. 4a is an illustration of a variable valve in the partially open position incorporating an elliptical shape according to one embodiment of the present invention.

FIG. 4b is an illustration of a variable valve in the open position incorporating a square shape according to one embodiment of the present invention.

FIG. 4c is an illustration of a variable valve in the open position incorporating a triangle shape according to one embodiment of the present invention.

FIG. 4d is an illustration of a variable valve in the open position incorporating a star shape according to one embodiment of the present invention.

FIG. 4e is an illustration of a variable valve in the open position incorporating a square shape with corrugated upper edges according to one embodiment of the present invention.

FIG. 5 is an illustration of a variable valve open to the full position.

FIG. 6 is an illustration of a variable valve assembly constructed into the interior of a ball valve according to an embodiment of the present invention.

FIG. 7 is an illustration of a variable ball valve according to one embodiment of the present invention with side actuation.

FIG. 8 is an illustration of variable valve rollers in a double opening configuration.

FIG. 9 is an illustration of a variable ball valve according to one embodiment of the present invention.

FIG. 10 is an illustration of the back side of the roller opening of a partially open variable valve illustrating media injection through spherical openings in hollow rollers according to one embodiment of the present invention.

FIG. 11 is an illustration of the back side of the opening of a partially open variable valve with raised protrusions for directing flow of media.

FIG. 12 is an illustration of sound and shock waves being controlled by a variable valve inside a conduit according to one embodiment of the present invention.

### DETAILED DESCRIPTION OF THE INVENTION

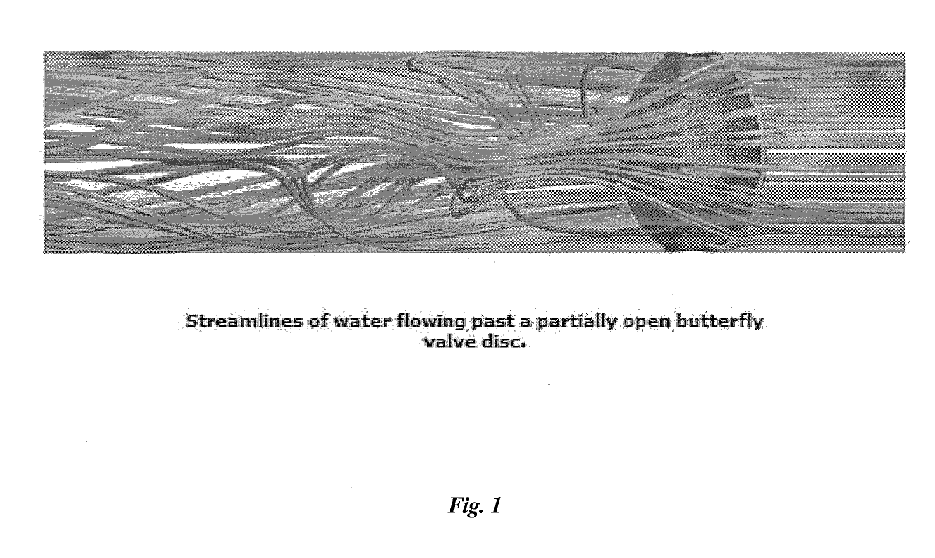

FIG. 1 illustrates the turbulence of a butterfly valve of the prior art. This turbulence causes heat and a disruption in the flow of the liquid or gas flowing through a pipe or conduit. Typically an additional length of material is needed to allow the turbulence to dissipate thereby causing additional cost. This causes problems with applications in which space is at a premium.

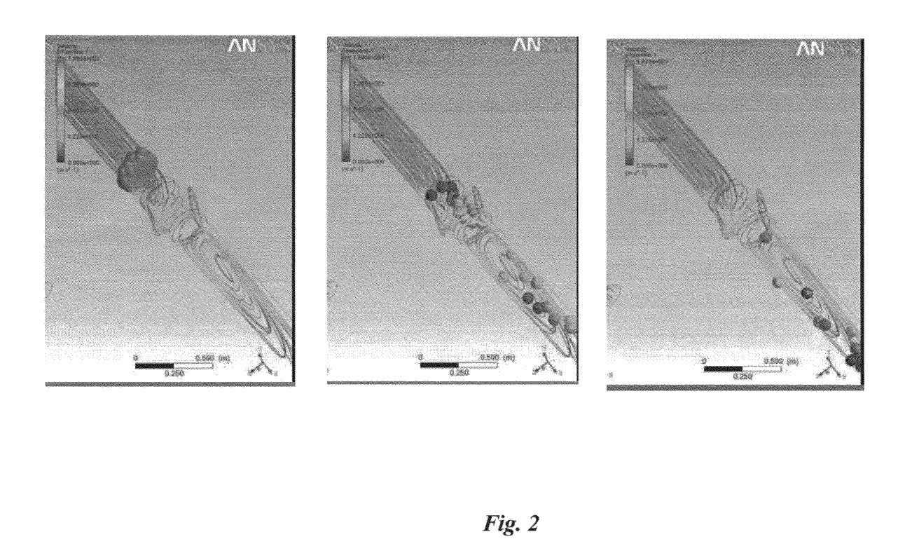

FIG. 2 is a typical illustration of the turbulence caused by a ball valve that is partially open. This turbulence causes the same problems as stated above with a butterfly valve. In a high pressure application this kind of turbulence causes major problems with heat and cavitation generated by the turbulence. If abrasive material is being transported the turbulence can cause much quicker wear on the conduit and the valve itself.

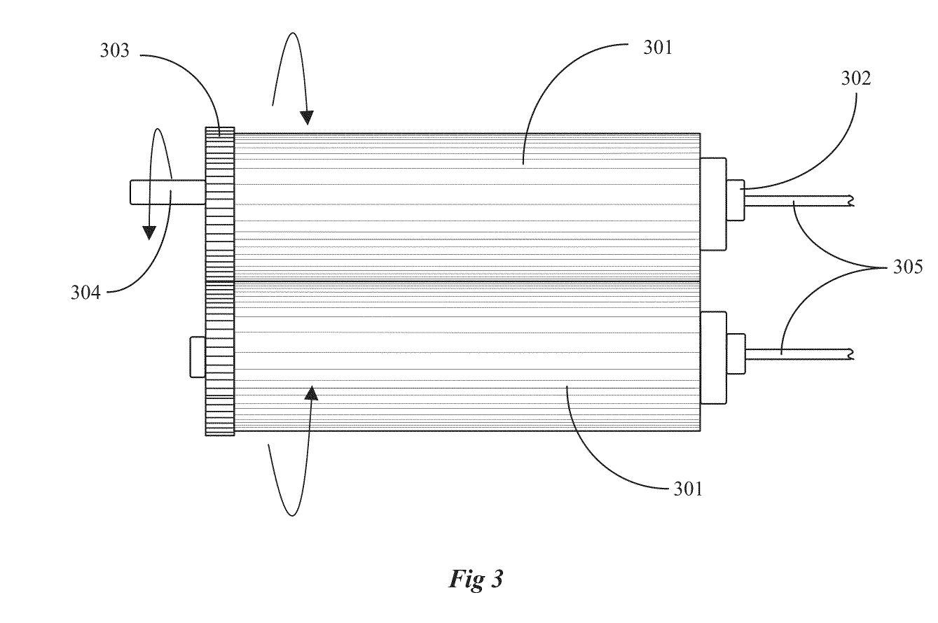

FIG. 3 is a variable valve of the present invention in a closed position. Gears 303 drive the rollers in opposite directions or the same direction. Element 304 is a stem that may be driven which is connected to gear 303. Element 302 is an inlet port through which other media or gases may be injected through rollers 301. Element 305 are separate conduits through which media may be communicated to rollers 301.

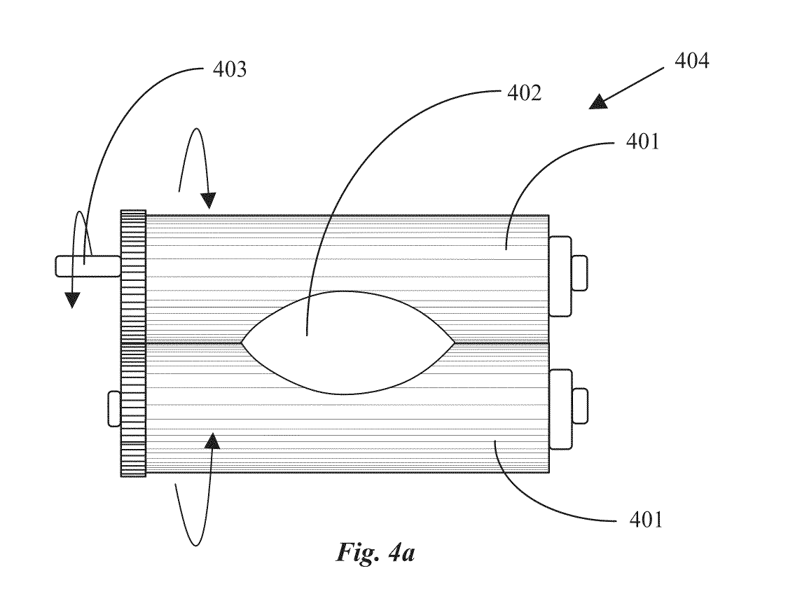

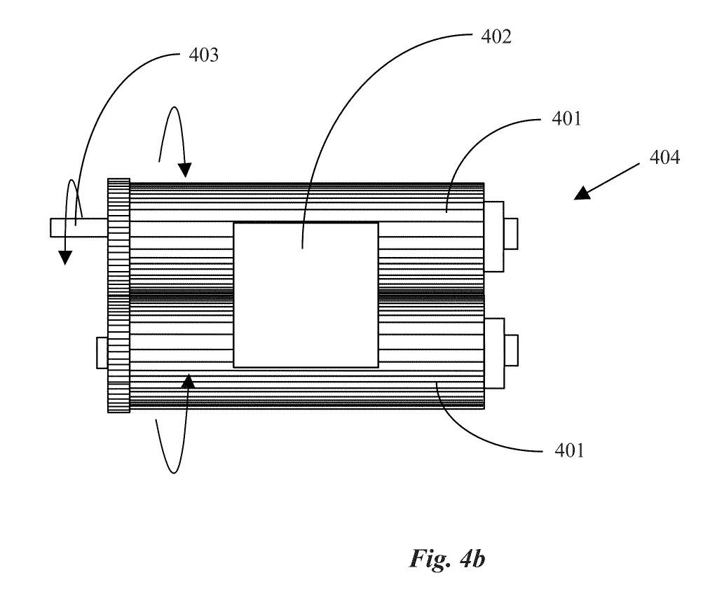

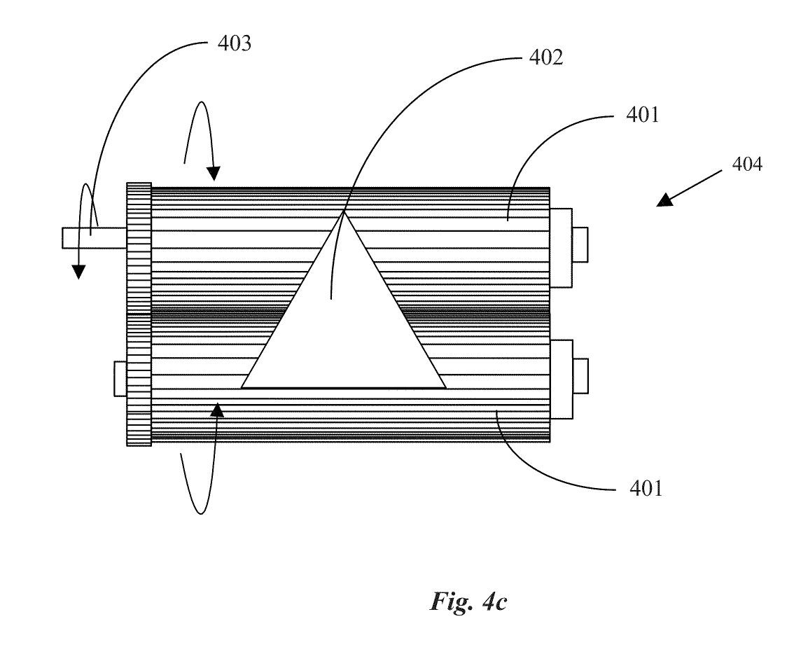

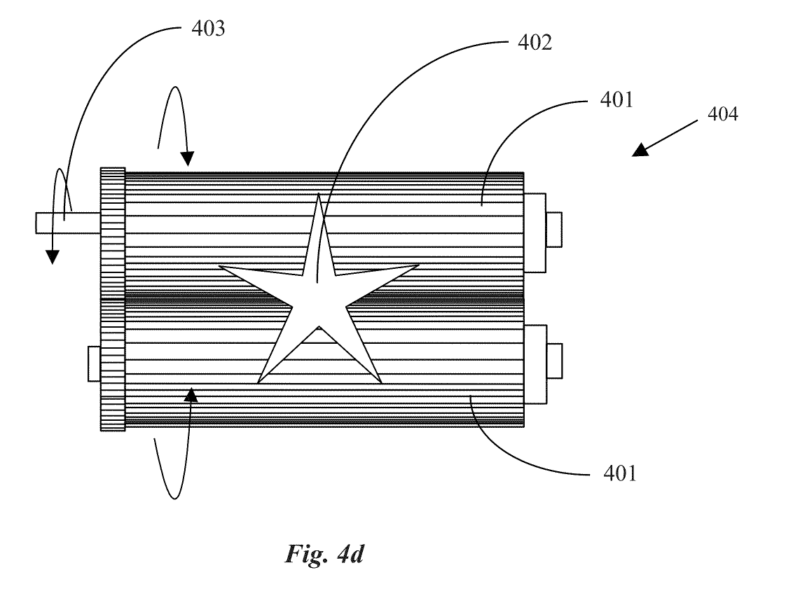

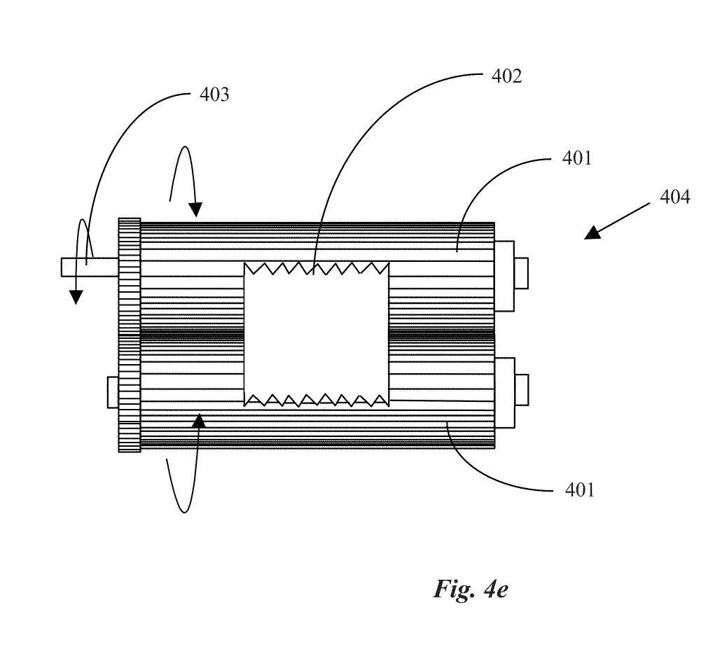

FIG. 4a is a variable valve 404 in a partially open position. Rollers 401 are rotated in opposite directions so that the opening forms an elliptical eye like shape 402. This shape causes less turbulence as gas or liquid flows through a conduit. In addition because of the cylindrical shape of the rollers 401 a boundary layer effect enables the gas or media to flow more smoothly through the valve. Element 403 can function as a gear driver driving the whole assembly and may incorporate a media injection function whereby additional media may be injected into main stream of media being controlled by variable valve assembly 404.

FIG. 4b is a variable valve 404 in a partially open position. Rollers 401 are rotated in opposite directions so that the opening forms a square opening 402. This square shape may be designed for many purposes one of which may be to purposefully cause cavitation in main media stream being controlled by variable valve 404. Rollers 401 may be tuned to exhibit a certain frequency which is desirable for obtaining cavitation in the main media stream in concert with the square shape. In addition, because of the cylindrical shape of the rollers 401, a boundary layer effect enables the gas or media to flow more smoothly through the valve. Element 403 can function as a gear driver driving the whole assembly and may incorporate a media injection function whereby additional media may be injected into main stream of media being controlled by variable valve assembly 404. In one embodiment variable valve 404 is used to control the flow of air or hydrogen through a hydrogen or hydroxy gas generation system. In is known to the inventor that the cavitation of water and other solutions produces the constituents of the H2o molecule as hydrogen and oxygen. Incorporating valve 404 into the inlet, outlet or in the water solution used during electrolysis can enhance the production of hydrogen and oxygen by inducing cavitation in the solution. Valve 404 can also be utilized to produce cavitation in gas streams associated with electrolysis systems.

FIG. 4c is a variable valve 404 in an open position. Rollers 401 are rotated in opposite directions so that the opening forms a triangle shaped opening 402. This triangle shape may be designed for many purposes one of which may be to purposefully cause cavitation in media or gas streams.

FIG. 4d is a variable valve 404 in an open position. Rollers 401 are rotated in opposite directions so that the opening forms a star shaped opening 402. This star shape may be designed for many purposes one of which may be to purposefully cause cavitation in media or gas streams.

FIG. 4e is a variable valve 404 in an open position. Rollers 401 are rotated in opposite directions so that the opening forms a corrugated square shaped opening 402. This corrugated square shape may be designed for many purposes one of which may be to purposefully cause cavitation in media or gas streams.

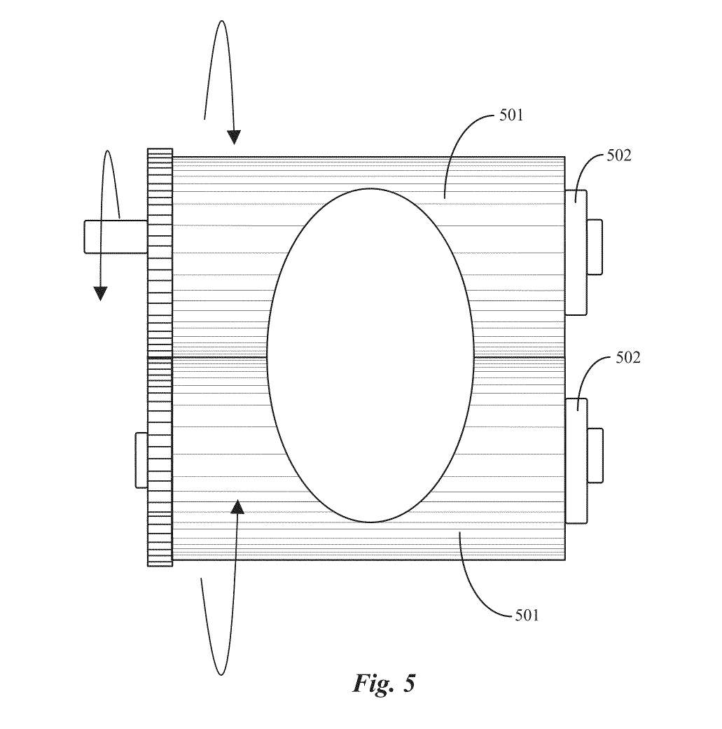

FIG. 5 is a variable valve in an open position. Rollers 501 are rotated in opposite directions so that the opening forms a round shaped opening. This round shape may be designed for many purposes one of which may be to purposefully cause cavitation in media or gas streams. In one embodiment element 502 is a piezoelectric element which can be operated in a range from 0 KHZ to all known frequency ranges. By energizing piezoelectric elements 502 the media contained within the rollers 501 may be energized and or enhanced or ionized as it is injected into the main media stream controlled by the variable valve. In one embodiment the shape of the opening of main variable valve may be engineered to cause cavitation and ionization by adjusting the frequency of piezoelectric elements 502 and by enhancing the shape of the opening of the main valve to purposefully cause cavitation.

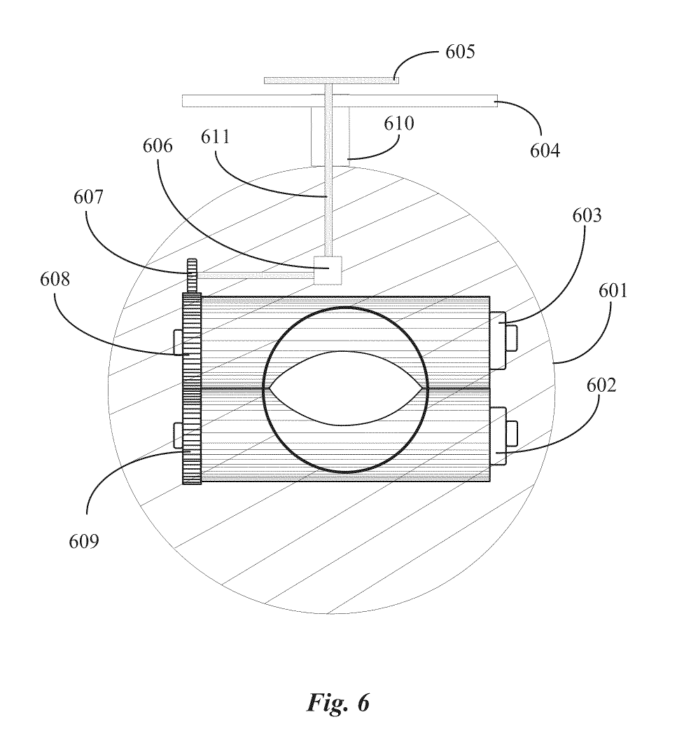

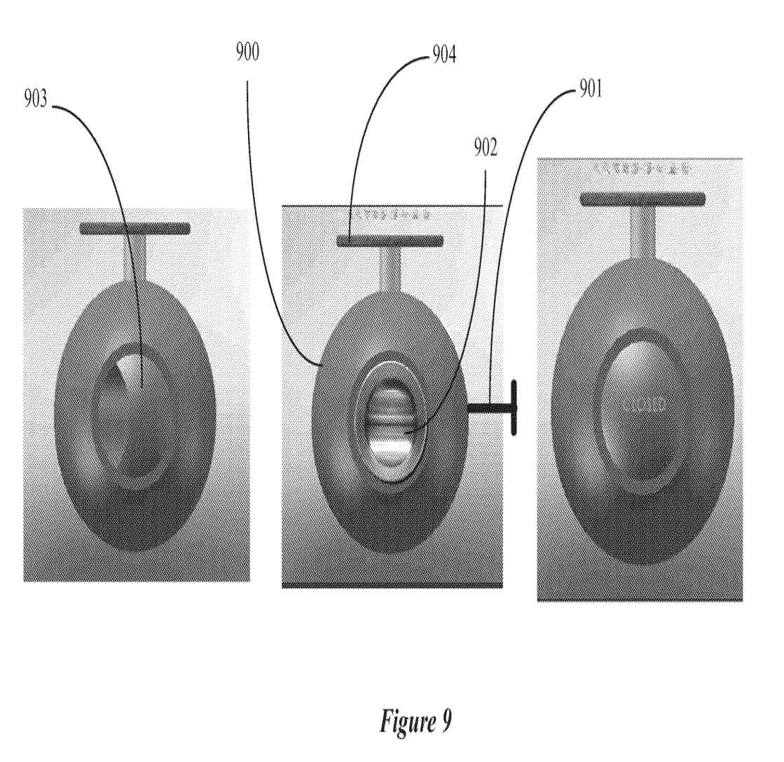

FIG. 6 is an illustration of a variable valve of the present invention incorporated into a ball valve. Surface 601 is the sealing surface as seen as element 903 of FIG. 9. Outer ball valve housing surface 900 of FIG. 9 is not shown in FIG. 6. Element 605 is an actuation mechanism for actuating the rollers 602 and 603. In this embodiment the rollers are rotating in opposite directions. In other embodiments the rollers may rotate in the same direction. In this embodiment element 605 is rotated to turn element 611 which is connected to element 606 which changes direction of rotation like a gear box. Element 606 may be of any design as long as direction of torque or rotation is changed so that gear 607 may be rotated in the proper direction for functioning of the variable valve. The actuation of the rollers 602 and 603 may take many forms such as hydraulic actuation, mechanical actuation, electrical actuation, wireless actuation and magnetic actuation. The actuation of the rollers 602 and 603 are not intended to be a limitation of the invention.

Element 604 is an actuation device which is affixed to element 610. Element 610 is affixed to surface 601 which is the sealing surface as seen as element 903 of FIG. 9. When element 604 is turned the whole assemble is rotated until a sealing condition is reached as seen in FIG. 9. In this embodiment handle element 605 can be rotated without handle 604 being rotated so that rollers may be rotated independently of surface 601.

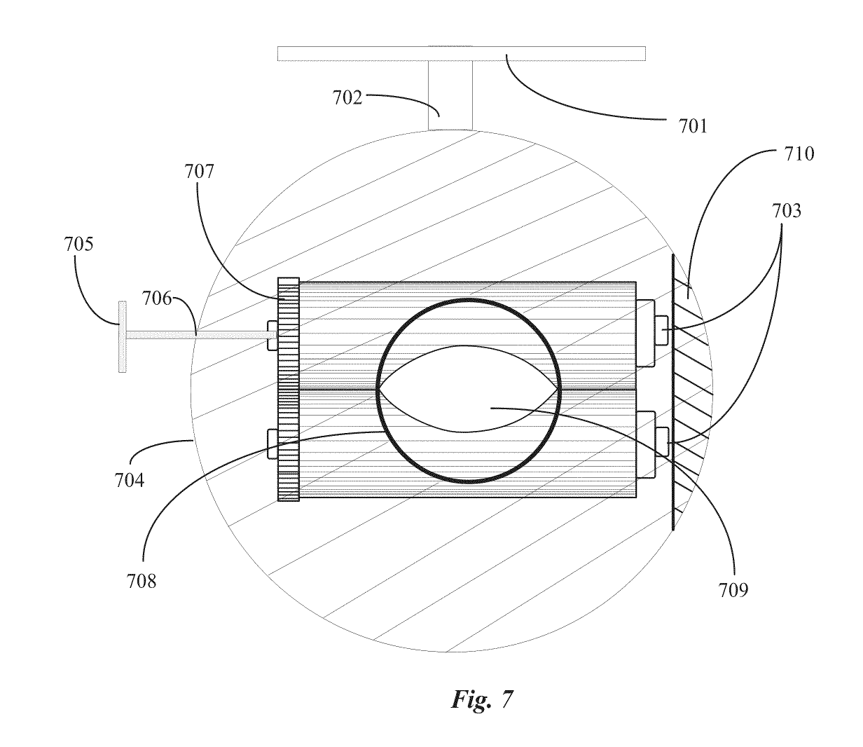

FIG. 7 is an illustration of a variable valve of the present invention incorporated into a ball valve. Surface 601 is the sealing surface as seen as element 903 of FIG. 9. Outer ball valve housing surface 900 of FIG. 9 is not shown in FIG. 7. In this embodiment the actuation is accomplished through a side actuation. Handle 705 turns shaft 706 so that gear 707 is rotated thereby rotating rollers 703 in opposite directions. Opening 709 can be finely adjusted this way. Element 701 and 702 will turn the whole assembly within an outer ball valve sealing surface. Element 708 indicates the fully opened shape in this embodiment. In one embodiment a section of the outer surface 710 is made to be removable so that roller assembly may be removed and service may take place.

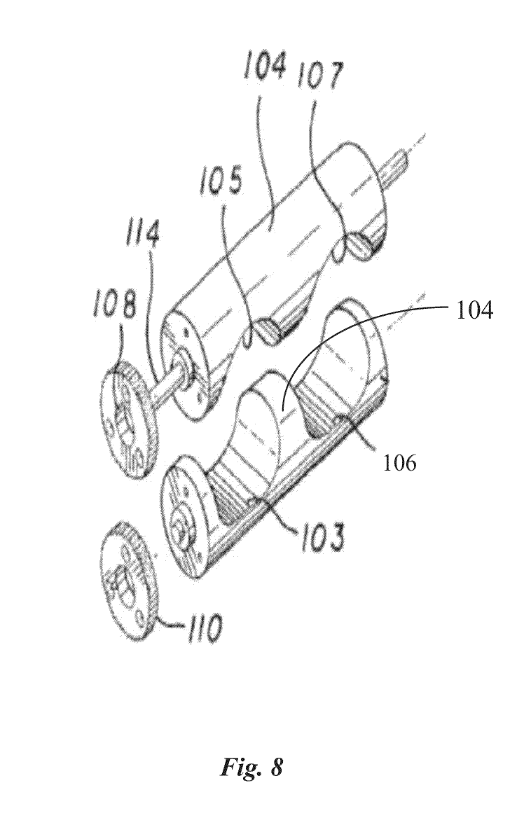

FIG. 8 illustrates 2 rollers 104 with ½ spheres cut out of each roller as seen in elements 103, 106, 105 and 107. Gears 108 and 110 rotate rollers 104 through connection 114. In this embodiment 2 media streams can be controlled at the same time. In other embodiments long rollers with multiple shapes can be utilized to control many media streams simultaneously. In this embodiment a mixture with many ingredients can be mixed at one time such as paint mixing etc . . .

FIG. 9 is an illustration of a variable ball valve according to one embodiment of the present invention. Rollers 902 are affixed into the interior of ball valve 900. In this way a very strong flow control can be maintained and a very good seal. This variable ball valve can be utilized under very high pressures without the disadvantages of turbulence and cavitation caused by the state of the art ball valves and butterfly valves. In this embodiment handle 904 will turn rollers 902 to one side of the interior surface of ball valve 900 thereby sealing the valve in the shut position. When in the open position the rollers 902 may be adjusted through handle 901. Actuation of rollers 902 may also be accomplished via internal electric solenoid, electromagnetically, hydraulically, mechanically or any other method. Element 903 is the sealing surface of the ball part of the valve. The figure on the right of FIG. 9 is an illustration of the variable ball valve in the closed position.

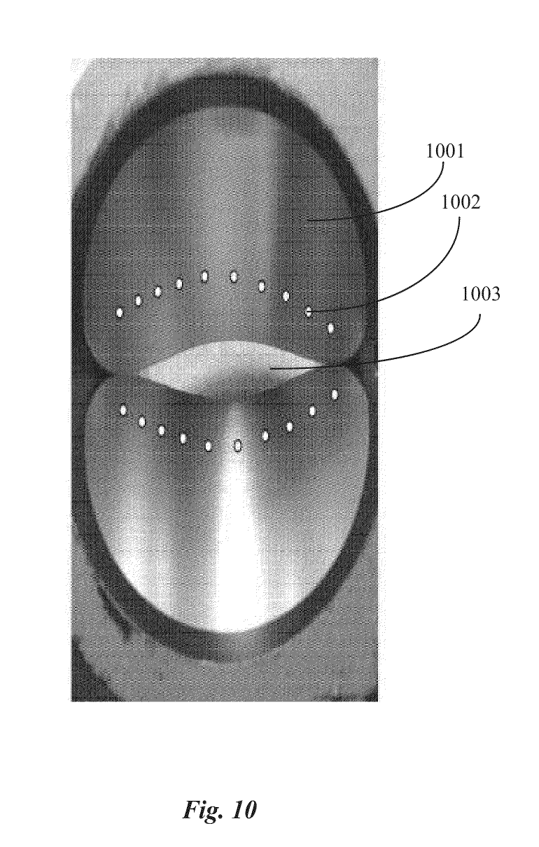

FIG. 10 is an illustration of the back side of rollers 1001. Openings 1002 communicate to the interior of the rollers 1001. In this way other gases and media may be communicated into the main media stream 1003. Openings 1002 may be of any shape desired to obtain the proper engineering for many applications. These openings can be used to adjust PH and to mix chemicals as they are moving through the conduit.

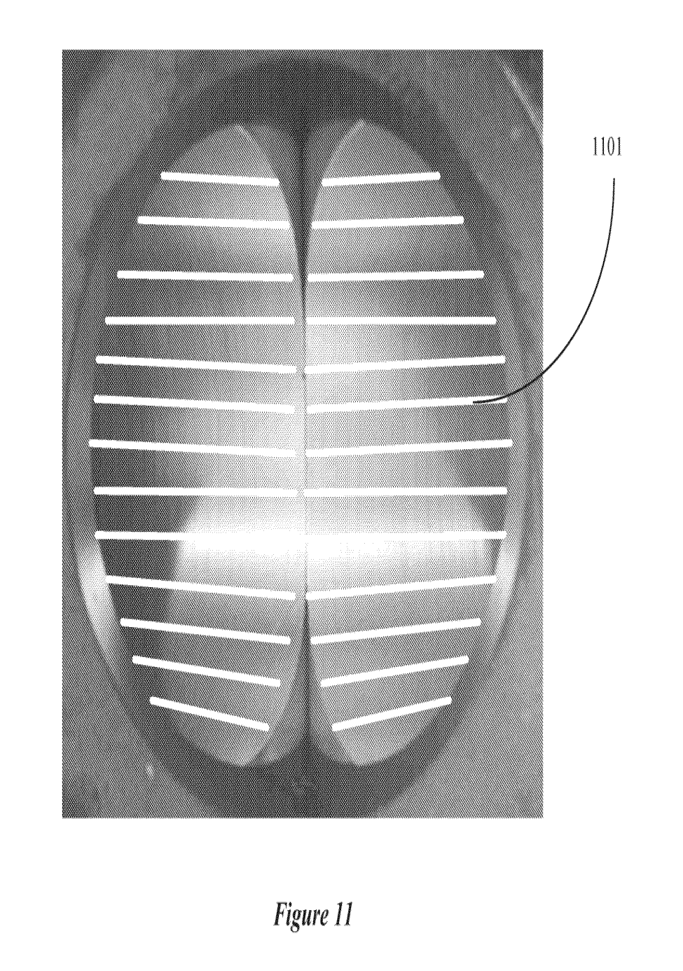

Openings 1002 may also be slots or any other shaped opening. In one embodiment of the invention rollers 1001 are non-electrically conductive or coated with a non-conductive material so that a high voltage may be applied to rollers 1001. The high voltage may be from 0 to any high voltage such as 20,000 volts. In this way a media or gas may be also ionized while traveling through variable valve or variable ball valve. Any media or gas injected through openings 1002 may also be ionized by passing through rollers charged with a very high voltage. In another embodiment a transformer is situated into the interior of one or each rollers 1001 so that the high voltage may be accomplished in this way. In this way one can control high pressure gas with precision with a variable valve that has a high pressure seal and at the same time ionize said gas with high voltage of any frequency. It is known to the inventor that with several valves in line adapted with the protrusions of FIG. 11 and the openings of FIG. 10 that an oil and water mixture can be separated into mostly oil and mostly water by adjusting the PH and squeezing the mixture through the multiple variable valves.

FIG. 11 is an illustration of the back side of the rollers of a variable valve or a variable ball valve. In this embodiment protrusion 1101 are engineered into the back side of the rollers. In this way the media flow traveling through main opening (see 1003 FIG. 10) can be altered and directed to enhance flow and reduce undesirable effects and flow characteristics. In one embodiment the protrusions 1101 are designed to induce a vortex flow through main opening (see 1003 FIG. 10). It is known to the inventor that a media flowing through a conduit may be made to flow with less resistance when a vortex flow is induced. In one embodiment multiple variable ball valves of the present invention are strategically placed throughout a conduit system so that the flow of said system may be improved and enhanced via the strategically placed vortex inducing variable valves or variable ball valves of the present invention.

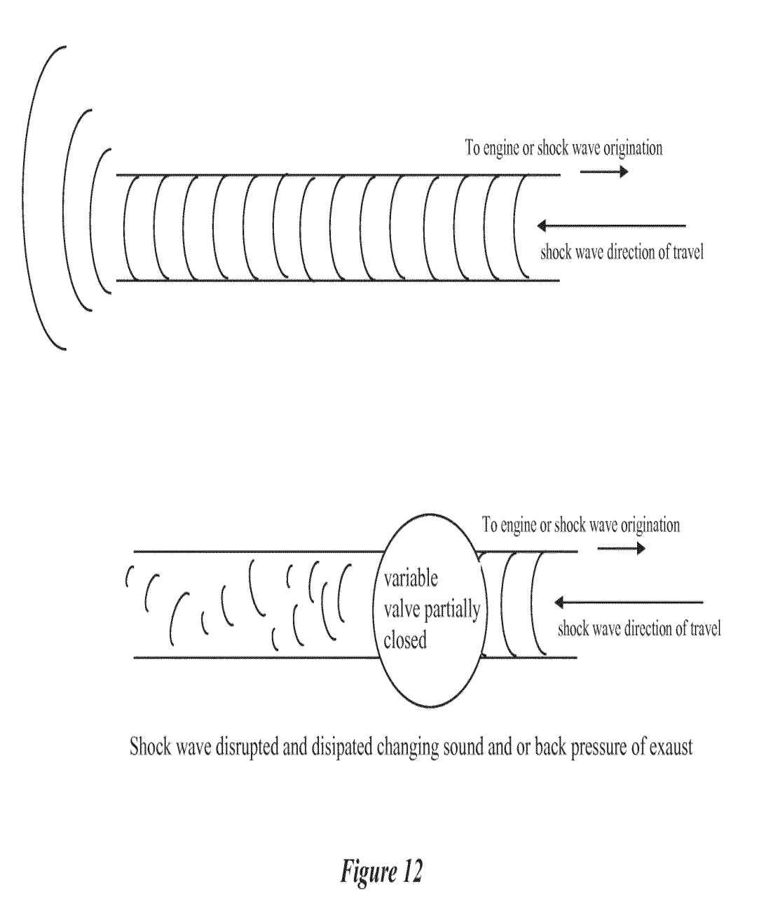

FIG. 12 is an illustration of how one or more variable valves can disrupt, change or block a shock wave or a sound wave. By opening and closing the valve a user can change the frequency of sound waves or shock waves caused by a car or motorcycle exhaust for example. The shock waves are in one form on the upstream side of the variable valve and are in a different form on the other side of the valve based on how far closed the valve is when the shockwave approaches and enters the valve. The back side of the valve as seen in FIG. 10 would be facing the source of the wave. This can be used for an adjustable sound for a motorcycle for example. This method can also be used to adjust and change the back pressure of an engine while running or driving. In one example a very loud exhaust on a Harley Davidson could be adjusted to a quiet setting when entering a quiet area.

In a fluid application sensors can detect a shock wave and speed of travel through the conduit timing the partial closing of a variable valve to coincide with its arrival at the valve. This will decrease the shock wave and save vital machinery from damage in the case of line hammer in a fluid system.

1. A valve comprising:
a housing having an inlet and an outlet port;
a ball having a through-passage with matching geometry to the inlet and outlet ports and an axis, the ball mounted within the housing and rotatable to align the through-passage with the inlet and outlet ports; and
a variable flow valve comprising two parallel substantially cylindrical rollers, one above the other, engaged to rotate together in opposite direction; each roller having a semi-circular cutout on one side in a direction of the axis of the through-passage, the rollers mounted within the ball with the axes of the rollers at right angles to the axis of the through-passage, such that the rollers in one rotated position completely block the through passage, and in another rotated position provide a fully open circular passage in the direction of the through-passage of the ball.
